(19) United States
(12) Patent Application Publication
(10) Pub. No.: US 2026/0154496 A1
(43) Pub. Date: Jun. 4, 2026

(54) APPARATUS AND METHOD FOR MANUSCRIPT CONVERSION

(71) Applicant: Research Factory and Publication Inc., Incheon (KR)

(72) Inventor: Jeong-Ju Yoo, Gyeonggi-do (KR)

(21) Appl. No.: 19/227,524

(22) Filed: Jun. 4, 2025

(30) Foreign Application Priority Data
Dec. 3, 2024 (KR) 10-2024-0177817
Feb. 7, 2025 (KR) 10-2024-0016239

(51) Int. Cl. G06F 40/186; G06F 40/284

(52) U.S. Cl. CPC G06F 40/186; G06F 40/284

(57) ABSTRACT

An apparatus and method for converting a manuscript by analyzing and tagging the structure of the manuscript using an artificial intelligence model are disclosed. According to an embodiment, a manuscript conversion apparatus may include: a tagging unit configured to receive original manuscript data and divide it into one or more parts, and to generate tagging data by matching sections for each divided part; and a conversion unit configured to convert the tagging data based on template configuration information according to an article type of a target journal to generate manuscript conversion data.

### CROSS-REFERENCE TO RELATED APPLICATION

This application claims priority to and the benefit of Korean Patent Application No. 10-2024-0177817, filed on Dec. 3, 2024, and Korean Patent Application No. 10-2025-0016239, filed on Feb. 7, 2025, the disclosure of which is incorporated herein by reference in its entirety.

### BACKGROUND

### Technical Field

The present invention relates to an apparatus and method for converting a manuscript by analyzing and tagging the structure of the manuscript using an artificial intelligence model.

### Background Art

When submitting a manuscript to a medical journal, the authors are required to revise the manuscript to comply with the specific format required by the journal. Currently, there are more than 7,000 medical journals listed in the Science Citation Index Expanded (SCIE), each with its own unique formatting requirements and detailed specifications. As a result, submitting the same manuscript to multiple journals requires the authors to manually revise the manuscript to match each journal's format.

This process consumes a significant amount of the researcher's time and effort and may delay the timely progress of research. Furthermore, when excessive time is spent adjusting the submission format, it causes more resources to be diverted to administrative tasks rather than the substantive progress of the research.

### SUMMARY

### Technical Problem

The objective of the present invention is to provide an apparatus and method for converting a manuscript by analyzing and tagging the structure of the manuscript using an artificial intelligence model.

### Technical Solution

According to one aspect of the present invention, a manuscript conversion apparatus may include: a tagging unit configured to receive original manuscript data as input and segment the original manuscript data into one or more parts, and to generate tagging data by matching sections for each segmented part; and a conversion unit configured to convert the tagging data based on template configuration information according to an Article Type of a target journal to generate manuscript conversion data.

According to another aspect of the present invention, the manuscript conversion apparatus may include: an interface unit configured to perform input and output of data; and a data processing unit configured to validate input reference data received through the interface unit, and to convert the input reference data based on the validation result and format of configured target journal.

### Effects

According to an embodiment, the manuscript conversion apparatus may automatically convert a manuscript format to meet the requirements of various journals, and may improve accuracy through user feedback. Furthermore, the manuscript conversion apparatus may reduce the inconvenience of the manuscript submission process and enhance research efficiency.

Additionally, by automatically analyzing and converting reference formats that vary by journal during academic manuscript writing, the manuscript conversion apparatus can save researcher's time and effort and provide a method to prevent publication delays caused by formatting errors. Accordingly, the process of writing and submitting manuscripts may be significantly improved by supporting accurate and efficient reference management and conversion using artificial intelligence and a user-friendly interface.

### BRIEF DESCRIPTION OF THE DRAWINGS

FIG. 1 is a block diagram of a manuscript conversion apparatus according to an embodiment.

FIGS. 2 to 6 are example views for explaining the operation of the manuscript conversion apparatus according to an embodiment.

FIG. 7 is a block diagram of the manuscript conversion apparatus according to an embodiment.

FIGS. 8 to 13 are example views for explaining the operation of a reference data generation apparatus according to an embodiment.

FIG. 14 is a block diagram illustrating a reference data generation apparatus according to an embodiment.

FIG. 15 is a flowchart illustrating a manuscript conversion method according to an embodiment.

### DETAILED DESCRIPTION

Hereinafter, one embodiment of the present invention will be described in detail with reference to the accompanying drawings. In describing the present invention, a detailed description of known functions and configurations that may unnecessarily obscure the subject matter of the present invention will be omitted. Furthermore, the terms described below are defined in consideration of the functions of the present invention and may vary depending on user, operator, or customary usage. Therefore, definitions should be based on the overall contents of this specification.

Hereinafter, embodiments of a manuscript conversion apparatus and method will be described in detail with reference to the accompanying drawings.

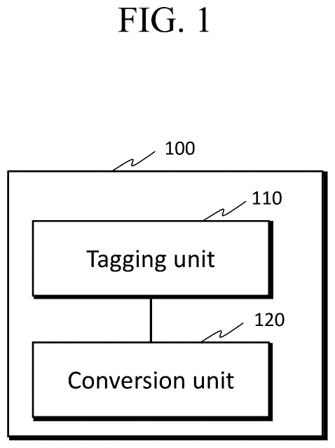

FIG. 1 is a block diagram of a manuscript conversion apparatus according to an embodiment.

According to an embodiment, the manuscript conversion apparatus 100 may include a tagging unit 110 and a conversion unit 120. The tagging unit 110 receives original manuscript data as input and segments the original manuscript data into one or more parts, and generates tagging data by matching sections for each segmented part. The conversion unit 120 converts the tagging data based on template configuration information according to an Article Type of a target journal to generate manuscript conversion data.

The manuscript conversion apparatus 100 may automatically analyze and convert the structure of the manuscript to match the format required by various journals. To achieve this, the manuscript conversion apparatus 100 may utilize one or more artificial intelligence (AI) models and programs to structurally analyze the contents of the manuscript and convert it to match the requirements of a specific journal, thereby resolving inefficiencies in the manuscript writing and submission process.

The manuscript conversion apparatus 100 may allow template configuration information for each journal to be set through a template editor. The template configuration information may include details such as required format, order, and formatting of the manuscript for each journal. Subsequently, the manuscript conversion apparatus 100 may analyze the input original manuscript data using an AI model and is capable of tagging components of the manuscript (e.g., title, abstract, introduction, materials and methods, etc.). During this process, a user may verify analysis results and, if necessary, make modifications and refinements using a drag-and-drop system provided in a web environment or program environment.

The manuscript conversion apparatus 100 may convert the tagged original manuscript data into the desired journal format based on the template configuration information. The converted result complies with the submission requirements and may be submitted without additional revision. Through this, researchers may avoid the hassle of repeatedly modifying the same manuscript for various journal formats and save time and effort. Furthermore, an AI model-based analysis and conversion process may ensure accuracy, support various journal formats, enhance research productivity, and simplify manuscript publication process.

In one example, the tagging unit 110 may analyze the structure of the manuscript in detail using an integrated program combining AI models and software, classifying the manuscript into several parts and tagging each part. The tagging unit 110 may utilize multiple fine-tuned AI models with different purposes and characteristics, and the AI models and programs may be organically integrated and operate in a pipeline structure. The pipeline structure is designed to be flexible so that the AI models and programs may be added or modified as needed.

For example, the pipeline structure of the tagging unit 110 may be composed of several programs that are sequentially connected to analyze and convert the manuscript data through a series of processing stages. The pipeline refers to a structure in which the output of one program is passed as input to the next program. The tagging unit 110 may include a series of organically connected stages, in which different programs sequentially process data, thereby completing a final manuscript format.

Specifically, the tagging unit 110 may first deliver the manuscript file (e.g., a Word file) input by the user to a preprocessing program to perform basic analysis and preparation. After preprocessing, the file is passed as input to the tagging program, where the AI model-based analysis automatically tags the structure of the manuscript. The tagged file may be visually displayed via a web browser or separate user interface, thereby supporting the user in manually reviewing or supplementing the content.

Additionally, the conversion unit 120 may also adopt the pipeline structure. The file reviewed by the user in the tagging unit 110 may be passed to the conversion program of the conversion unit 120. The conversion program may convert the file into the final format according to the journal template predefined by the user. The journal template may be created in a separate program called a Journal Template Editor and may define in detail the format required by the journal. In this process, multiple AI models may also be applied to perform final conversion.

As such, the pipeline structure of the tagging unit 110 and the conversion unit 120 represents a structure in which the stages of preprocessing, AI model-based analysis, user modification, and final conversion are organically integrated, and the output of each step is used as input to the next stage to progressively convert the manuscript data into the completed format.

The tagging unit 110 may utilize multiple fine-tuned AI models with different purposes and characteristics to analyze and tag the structure of the manuscript in detail. For example, when tagging the author part of the manuscript, an AI model may be used to verify whether degree information included in the author information is missing. The AI model may be specialized in analyzing and tagging whether each author's degree information is present. In addition, another AI model may be used to identify and classify each section while tagging major textual parts of the manuscript, and to extract necessary items and classify parts accordingly. Various other AI models with different purposes and functions may also be fine-tuned and applied in the tagging unit 110.

In one example, the AI model may be trained using large amounts of training data for tagging during the fine-tuning process. For example, when manuscript text is input, the AI model may be trained to output tagging information. The fine-tuning may be performed by providing the AI model with large, organized data files, and the time required may vary depending on the amount of data. The fine-tuning method may also differ depending on the type of AI model or approach of the service provider.

According to one embodiment, the tagging unit 110 may receive original manuscript data as input and segment the original manuscript data into one or more parts. For example, manuscript sections may include introduction, materials and methods, results, discussion, conclusion, and references. In this case, the tagging unit 110 may classify the manuscript text into parts based on such sections.

For example, the tagging unit 110 may classify the text “This study is a preliminary investigation to verify the efficacy of a new drug and aims to supplement the limitations of existing therapies . . . ” as belonging to the introduction part, as the text describes the background and objective of the study. In another example, the text “The experiment was conducted by classifying subjects into an experimental group and a control group, administering 50 mg of the drug to each group, and observing progress at one-week intervals . . .” may be classified as materials and methods part, as the text explains the experimental design and procedure. In this manner, the tagging unit 110 may segment the text in the manuscript into parts such as results, discussion, conclusion, and references according to the content.

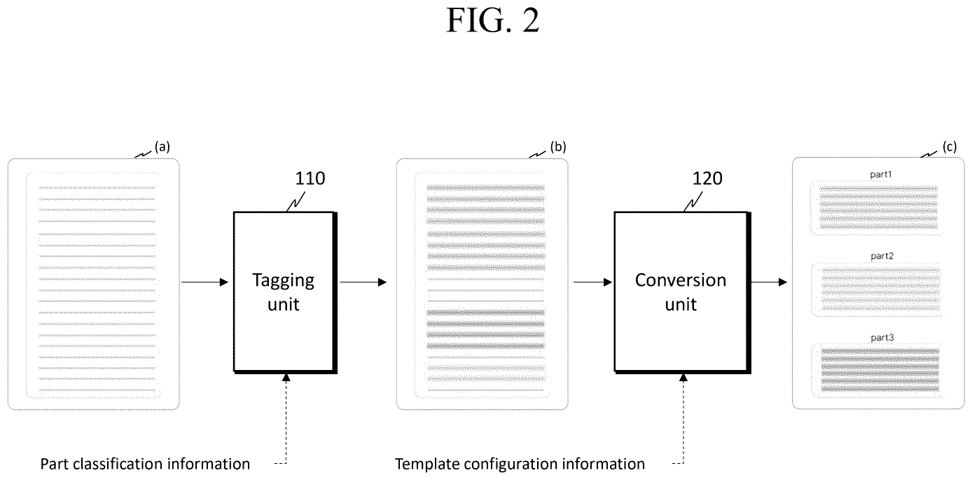

According to one embodiment, the tagging unit 110 may segment the manuscript into one or more parts based on part classification information. Referring to FIG. 2, the tagging unit 110 may receive the original manuscript data as input (a), segment text of the original manuscript data into one or more parts, and generate tagging data (b).

In this stage, the part classification information may include format information set according to the Article Type of the target journal, such as an Original Article or Review Article. In other words, this is data that defines components, format, and order required for each Article Type.

Specifically, if the author intends to write a manuscript in the format of an Original Article, the part classification information may include section configurations such as introduction, materials and methods, results, and discussion, as well as the format and placement of each section. Based on this configuration information, the tagging unit 110 may receive the original manuscript as input and automatically identify and segment the parts according to the template. For example, in the case of the Original Article, if the configuration dictates that the introduction is required to come first, followed by materials and methods, results, and discussion, the tagging unit 110 may identify and segment these parts from the original manuscript. Then, the tagging unit 110 may match sections for each part based on the part classification information.

According to one embodiment, the tagging unit 110 may include an AI model that receives style guide data as input and generates part classification information according to the Article Type of the target journal.

For example, a medical journal's style guide may specify that the article should be structured in the order of “introduction, materials and methods, results, discussion, conclusion,” and that the title is required to be written in bold 14-point Times New Roman font. It may also require citations to be marked using reference numbers in square brackets at the end of each paragraph. Upon receiving such style guide data as input, the AI model may analyze the section structure, formatting rules, and citation style to generate part classification information. Through this process, the manuscript may be automatically structured to conform to the target journal's format.

According to one embodiment, the tagging unit 110 may include an AI model that analyzes text contained in the original manuscript data based on part classification information and segments the text into parts. This AI model may analyze content and position of each text in the original manuscript and classify it as belonging to the introduction, materials and methods, results, author Information, etc.

For example, a text such as “Kim XX, M.D., Ph.D., College of Medicine, XX University” may be classified as part of the author information. Since the text contains author's name, academic degree, and institutional affiliation, the text may be recognized by the AI model as author information through comparison with the section classification information. Similarly, a text like “This study was conducted to analyze the effects of a new treatment method . . . ” may be segmented as part of the introduction, “The drug was administered to 50 patients and progress was monitored . . . ” as part of the materials and methods, and “Significant improvement was observed compared to the control group . . . ” as part of the results.

According to one embodiment, the tagging unit 110 may include one or more AI models for analyzing missing information in at least one of the parts. For example, the tagging unit 110 may determine whether required parts are missing based on information on parts designated as mandatory. For example, if the abstract is set as a required section, the tagging unit 110 may detect its absence and request the user to provide it. Similarly, the tagging unit 110 may determine whether any required information is missing based on information designated as mandatory. For example, if the author's degree information is designated as mandatory, an AI model may be used when tagging the author part to verify whether degree information is included.

For example, when the author information should include “Kim XX, M.D., Ph.D. ,” the AI model may determine the text to verify whether degree information is missing for each author. If degree information is missing for specific authors, the tagging unit 110 may detect this and notify the user. This enables the tagging unit 110 to automatically verify for missing information in specific parts of the manuscript and to help prevent the missing information.

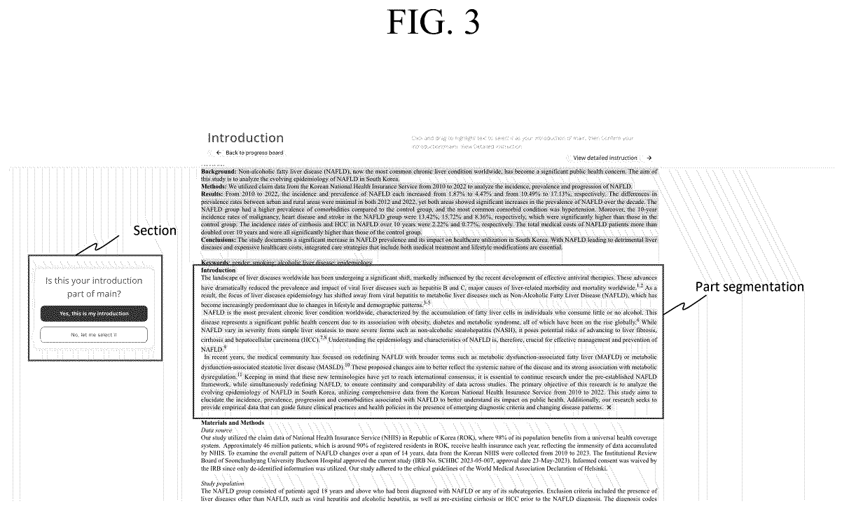

According to one embodiment, the tagging unit 110 may output at least one of the text with part segmentations indicated, section information matched to each part, and missing information. Referring to FIG. 3, after segmenting the text included in the original manuscript data into parts, the tagging unit 110 may output section information for the segmented parts and receive confirmation from the user.

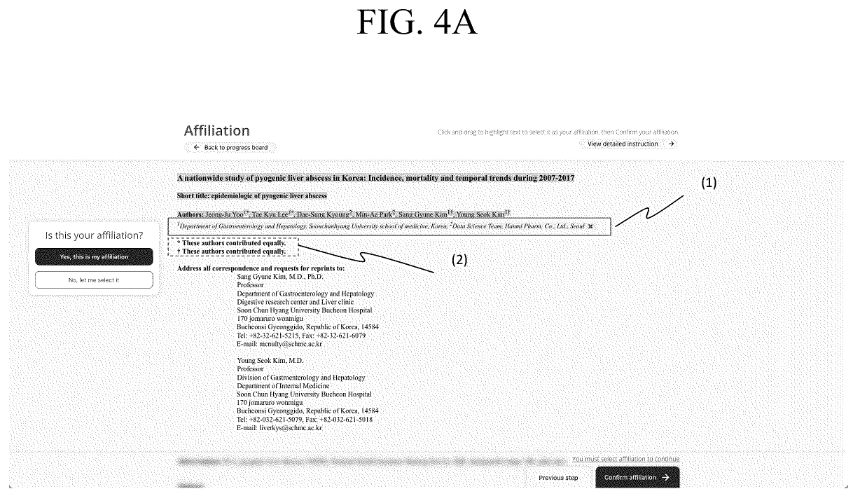

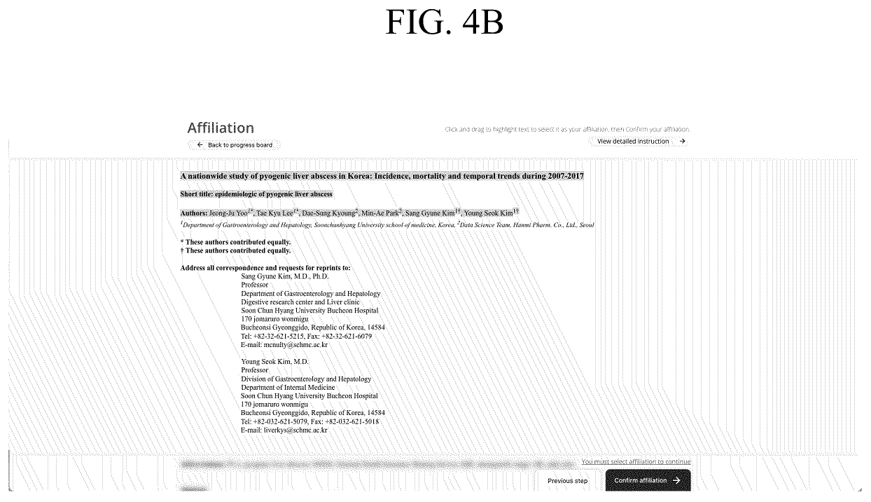

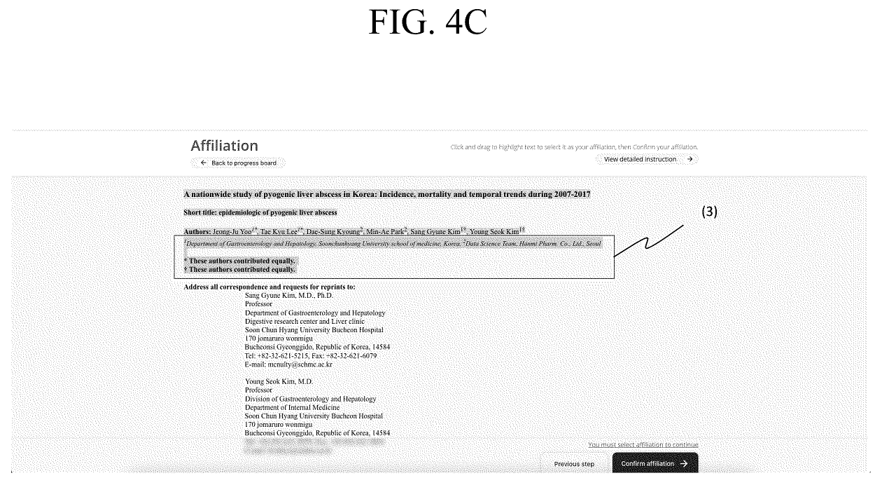

According to one embodiment, the tagging unit 110 may receive, from the user, a modification request input to modify at least one of text with indicated part segmentations, section information matched to each part, and missing information. For example, as illustrated in FIGS. 4A to 4C, the user may visually verify the analysis results of the tagging unit 110 via a web or software environment. In this manner, the user may quickly review the accuracy of the analysis, and if an incorrect part is found, the user may manually tag the incorrect part to immediately modify it.

In one example, the tagging unit 110 may receive a modification request input from the user to modify at least one of the text with indicated part segmentations, the section information matched to each part, and the missing information. For example, when tagging affiliation information in a medical manuscript, the user may verify information automatically tagged by the AI model as shown in FIG. 4A. However, the user may wish to include not only the tagged content (1) but also other related content (2) below it within the affiliation part.

In this case, as shown in FIG. 4B, the user may delete the information automatically tagged by the AI model and, as shown in FIG. 4C, manually drag or input the desired text to tag it as the affiliation part. Through the tagging unit 110, the user may easily modify not only the content tagged by the AI model but also any manually added content. This approach is applicable to all parts of the manuscript, and the tagging unit 110 may provide a flexible interface that allows the user to freely adjust each part as desired. In this manner, the tagging unit 110 may receive, from the user, modification requests for each part with respect to text segmentations, section matching information, and missing information, thereby improving accuracy.

According to one embodiment, the tagging unit 110 may train an AI model that generated the information subject to the modification request, based on the modification request input. For example, when tagging affiliation information as described above, the user may manually drag other contents of relevant paragraphs to add them to the part. In such cases, the modification request may serve as valuable data for training the AI model of the tagging unit 110. That is, based on the user's modification request input, the tagging unit 110 may train the AI model so that similar types of text may be properly tagged in future tagging tasks.

In one example, the tagging unit 110 may specify Article Type to be processed by the user, and automatically analyze and supplement the manuscript data based on predefined Step Data for each Article Type. In this case, a StepSet may correspond to a section, and a step may correspond to a subsection.

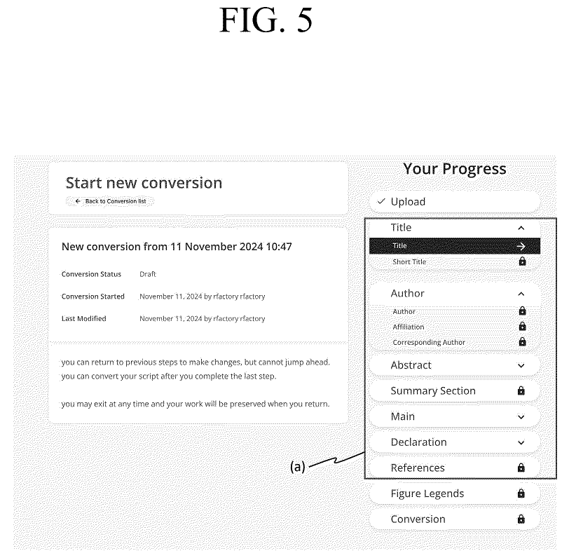

For example, as shown in FIG. 5, the conversion program for an Original Article may consist of multiple stages for tagging each element of the manuscript. These stages may proceed in a predetermined order. In one example, a stage may include one or more sections (a), and the stages may proceed in the order of the sections. The StepSet represents major sections of the manuscript (e.g., introduction, materials and methods, results, discussion, etc.), and the detailed stages within each section may be managed as subsections. While Original Article may have a large number of subsections (step), this configuration is limited to the Original Article only. In other Article Types of journals, the elements to be tagged may differ. Accordingly, the tagging unit 110 may flexibly perform tagging by reflecting the section and subsection structures suitable for each Article Type and special case.

These sections StepSet and subsections (step) may be managed as data for each Article Type. Therefore, even if a new tagging format is required, it may be quickly supported by simply adding a data structure. In this way, the tagging unit 110 may accurately analyze manuscript data for various Article Types and structure the manuscript in accordance with the journal's requirements.

According to one embodiment, the conversion unit 120 may determine each section as at least one of a missing section, a section requiring modification, and a section not requiring modification, based on tagging data and template configuration information. In one example, the conversion unit 120 may include an AI model that receives style guide data as input and generates the template configuration information based on the Article Type of target journal. For example, the template configuration information may include part classification information in whole or in part.

In one example, the missing section refers to a section that is included in the template configuration information but not present in the tagging data. For example, if the abstract section is mandatory according to the journal's requirements but is missing from the actual manuscript, this would be considered the missing section. The conversion unit 120 may recognize this as the missing section and notify the user. The conversion unit 120 may also generate corresponding to the missing section using an AI model. The section requiring modification refers to a section that exists in the tagging data but does not meet the criteria defined in the template configuration information, such as word count or format. For example, if the conclusion section is required to be limited to 200 characters according to the template configuration information but the actual content is 300 characters long, the conversion unit 120 may designate this section as the section requiring modification. The conversion unit 120 may then notify the user or use an auto-summarization function to modify the section in accordance with the journal's requirements.

According to one embodiment, the conversion unit 120 may convert the tagging data in a predetermined order to generate a manuscript conversion data. For example, the conversion unit 120 may convert the tagging data in an order of sections included in the template configuration information to generate the manuscript conversion data. In one example, the template configuration information is data that represents the manuscript format required by the target journal. For example, some journals may require a five-part abstract, while others may require a four-part or custom-formatted abstract. The conversion unit 120 may define each journal's format in advance in the template configuration information and convert the manuscript accordingly. The manuscript input by the user may be provided in various formats. Therefore, the conversion unit 120 first recognizes and tags the structure of each part of the manuscript through a tagging process.

Subsequently, the conversion unit 120 checks the template configuration information of one or more target journals for conversion. Based on the section order and requirements defined in the template configuration information, the conversion unit 120 may convert the tagging data in accordance with the requirements of the target journal and may generate a final manuscript.

In one example, the conversion unit 120 may summarize a specific part of the manuscript or generate a new part by referencing another part during conversion. This process may be applied when the components of the manuscript do not match the target journal's requirements or when a specific part is not present in the original manuscript. For this purpose, the conversion unit 120 may perform generation function and summarization function separately.

For example, the generation function may be used when a specific part is entirely missing from the original manuscript. If a short title is mandatory in the target journal but is not included in the original manuscript, the conversion unit 120 may reference the title and generate a new short title using an AI model. Likewise, in cases where key points are mandatory for the target journal but are not present in the original manuscript, new key points may be generated by extracting the main points from the content of the manuscript. If an abstract with a very specific or structured format is required, the conversion unit 120 may analyze the entire manuscript and generate a new abstract accordingly.

The summarization function may be used when a required part is present in the original manuscript but needs to be shortened according to the target journal's requirements. For example, if the short title is required to be limited to 50 characters, and the original short title exceeds that limit, the conversion unit 120 may summarize the title. Since different journals may impose different limits on word count or character count (including whether or not spaces are included) the conversion unit 120 may summarize the text accordingly and present it to the user.

According to one embodiment, the conversion unit 120 may include at least one of one or more AI models for generating text data for a missing section and one or more AI models for generating text data for a section requiring modification. That is, the conversion unit 120 may use AI models to generate the necessary text data for the missing section or to summarize text data that requires modification to fit the template configuration information.

According to one embodiment, when converting a missing section during conversion of tagging data, the conversion unit 120 may select an AI model related to the missing section from among one or more AI models for generating text data for the missing section, and generate text data corresponding to the missing section.

For example, if the conclusion section is missing, the conversion unit 120 may select an AI model for generating conclusion text and automatically generate appropriate content for the conclusion section. This AI model may refer to the earlier parts of the manuscript (such as introduction, materials and methods, and results) and generate a summary and conclusion sentences appropriate for the conclusion section, thus completing the missing conclusion section.

According to one embodiment, when converting a section requiring modification during conversion of tagging data, the conversion unit 120 may select an AI model related to the section requiring modification from among one or more AI models for generating text data for a section requiring modification, and may generate text data corresponding to the section requiring modification.

In one example, if a section requiring modification is present, the conversion unit 120 may select and use one AI model from among one or more AI models for generating necessary text. For example, if the abstract section is required to be limited to 150 characters according to the template configuration information but exceeds 200 characters in the tagging data, the conversion unit 120 may use an AI model for abstract summarization to summarize the abstract to within 150 characters according to the template configuration information and generate text data.

According to one embodiment, the conversion unit 120 may determine a section of the tagging data to be input into the AI models for a missing section and a section requiring modification, based on reference section information included in the template configuration information.

For example, if the conclusion section is required according to the template configuration information but is missing from the original manuscript, the template configuration information may be defined as such that the conclusion section refers to the results section and discussion section. Based on the reference section information, the conversion unit 120 may use the text from the results section and discussion section as input data for the AI model to generate the conclusion section. The AI model may then summarize the content of results and discussion, and derive a conclusion to generate text data for the missing conclusion section.

In another example, if the abstract section is required to be limited to 150 characters according to the template configuration information, but currently the abstract exceeds 200 characters, the conversion unit 120 may use an AI model to summarize the abstract. At this point, the template configuration information may be defined such that the introduction section and results section may be referenced for summarizing the abstract. Based on the reference section information, the conversion unit 120 may input key contents from the introduction section and results section into the AI model, and generate an abstract summarized to within 150 characters.

As described above, based on the reference section information defined in the template configuration information, the conversion unit 120 may retrieve content necessary for each section from other sections and use the content as input data for the AI model, thereby supplementing a missing section and a section requiring modification in accordance with the journal requirements.

In one example, for standardized format conversion tasks that do not require an AI model, the conversion unit 120 may process them in parallel using programs. For tasks that require an AI model, the conversion unit 120 may send input data to the AI model and wait for the result, which may cause a certain waiting time. For example, complex text generation or summarization tasks may require processing of an AI model.

In contrast, the standardized format conversion tasks may be directly processed by a program according to fixed rules without requiring an AI model. For example, conversion tasks conforming to a predefined format, such as relocating specific items of a declaration to specific pages, may be consistently executed by a program without the need for an AI model. These tasks do not require waiting time and may be processed in parallel within the program. Thus, the conversion unit 120 may rapidly process tasks that do not require an AI model in parallel and individually process tasks that require an AI model, thereby improving the overall conversion efficiency.

In one example, the conversion unit 120 may be configured in a pipeline structure, thereby enabling flexible addition, modification, or deletion of AI models and various functions. This pipeline is composed of multiple independent modules, each of which is connected to form the overall conversion unit 120. For example, if a new function or part needs to be added according to a specific manuscript format, by simply adding a new module that performs the corresponding function to the conversion unit 120, the conversion unit 120 may be easily extended without requiring modification of the entire program. Furthermore, even when an AI model is used, a new AI model may be easily applied by modifying only the AI model configuration within the module including the AI model. Through this, the conversion unit 120 may be easily modified and extended, and may respond flexibly to the requirements of various journals and Article Types.

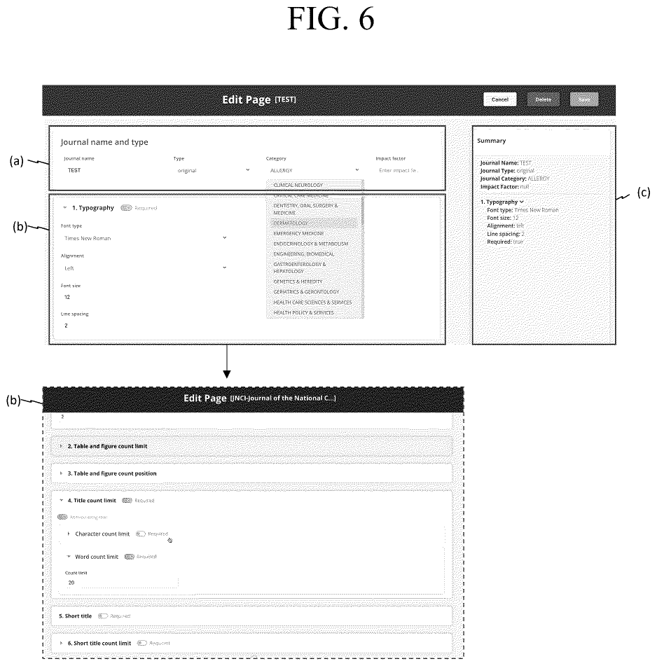

FIG. 6 illustrates an interface for generating and modifying template configuration information. Referring to FIG. 6, the interface is a page including configuration for converting a manuscript to comply with the requirements of various journals, and may be broadly classified into sections (a), (b), and (c). For example, section (a) may be used to set the basic information of the template, such as a journal name, an Article Type, a category, and an impact factor. This section plays a role in defining the basic attributes and requirements of the journal.

Section (b) provides various options to convert a tagged manuscript file according to the guidelines of a specific journal. For example, formatting such as font type, font size, and line spacing of the manuscript may be specified through typography option. Each option includes a “Required” button that may be activated to enforce mandatory application of the corresponding option. This section focuses on specifically defining the formatting and rules of the manuscript to meet journal's detailed requirements.

Finally, section (c) may filter and display only the options for which the “Required” button has been activated among the options set in section (b). This allows the user to efficiently check and manage the mandatory options. Especially, section (b) includes options beyond typography for configuring various formatting and rules to accommodate the differing requirements of each journal.

According to one embodiment, when the tagging data required as input to the AI model for a missing section or a section requiring modification does not exist, or some of the tagging data is missing, the conversion unit 120 may generate arbitrary data or generate data based on other sections. In such cases, the conversion unit 120 may also notify the user that the data was generated arbitrarily or based on other sections. For example, if the abstract section is required to be written using information from the introduction section but the introduction section does not exist, the conversion unit 120 may generate arbitrary data to compose the abstract section.

In one example, if the tagging data required for generating a missing section does not exist, the conversion unit 120 may generate the missing section data based on other tagging data necessary for generating the nonexistent tagging data. For example, if the introduction section does not exist but is needed to write the abstract, the conversion unit 120 may input the body text section required to write the introduction section and use to generate the abstract. In such cases, the conversion unit 120 may notify the user that this approach has been used.

In another example, if a specific journal requires the author's email address but such information is not present, the conversion unit 120 may generate arbitrary data to generate an email address. In this case, the conversion unit 120 may notify the user that the email address was generated using arbitrary data.

Through this, the user may be made aware that certain data was either arbitrarily generated or generated based on other data, and may verify and modify it as needed.

According to one embodiment, when the tagging data required as input to the AI model for a missing section or a section requiring modification does not exist, or some of the tagging data is missing, the conversion unit 120 may request the user to input the information. That is, when the AI model cannot obtain the necessary data to generate or supplement a missing section or a section requiring modification, the conversion unit 120 may provide a notification and prompt the user to supply the information.

For example, information from the introduction section is generally required to generate the abstract section. However, if the introduction does not exist in the original manuscript and tagging data for generating the abstract cannot be obtained, the conversion unit 120 may recognize the absence of the introduction data and request the user to input or supplement the introduction content. In another example, if the author's contact information is required in the author information section but is not present in the tagging data and cannot be found in other sections of the manuscript, the conversion unit 120 may request the user to input the contact information manually.

In this manner, the conversion unit 120 may request the user to input essential data when necessary information is insufficient, thereby supplementing the manuscript to meet requirements of the journal, and may improve the completeness and accuracy of the final manuscript.

In one example, the manuscript conversion apparatus 100 may further include an option management unit (not shown). For example, an Option Rule Set is a function that applies additional validation rules to the template configuration information and may be used when unique validations are required for individual items in addition to the basic validation routine. All template configuration information is subjected to the basic validation routine that allows only valid values predefined on the server. However, for some options, more complex validations beyond the basic validation may be necessary, and in such cases, the Option Rule Set may be applied.

For example, the basic validation routine for the data availability option may be as follows:
The “Copy and inject to main method” function may be activated or deactivated regardless of whether it is marked as “Required”.
The “Position” value is required to be selected from predefined options, and if marked as “Required,” at least one value is required to be selected.
The “Order” value is validated in the same way as the “Position”. The “Subheading” is required to include text, and if marked as “Required,” it cannot be left blank.

However, in specific situations, the basic validation alone may not be sufficient. For example, if the “Position” value is set to “Main method”, an additional rule may be needed to prevent activation of the “Copy and inject to main method” function. Such a rule may be applied as the Option Rule Set. Only when both the basic validation and the rules defined in the Option Rule Set are satisfied, the configuration is considered valid, and the template configuration information may be generated or modified. If validation fails, an error message may be displayed.

The option management unit is used during the process of converting a manuscript in accordance with a specific journal's guidelines, and because journal's requirements may vary significantly, flexible rule configuration like this is necessary. Through this, the user may automatically convert a manuscript based on predefined options by simply selecting the journal name. The user may efficiently configure option data using the Option Rule Set.

According to one embodiment, the manuscript conversion apparatus 100 may further include a data processing unit 130 configured to validate input reference data included in the original manuscript data, and to convert the input reference data based on the validation result and the format of the configured target journal. For example, the tagging unit 110 may receive original manuscript data as input and segment it into one or more parts. sections of the manuscript may include introduction, materials and methods, results, discussion, conclusion, and references. In the case of reference conversion, the manuscript conversion apparatus 100 may perform the conversion task using the data processing unit 130.

References included in a manuscript refer to a list of sources that the researcher referenced or cited during the manuscript writing process. References enhance the credibility of the manuscript and help readers obtain additional information. However, each journal often requires its own unique reference format, which may vary in the order and presentation of elements such as authors, title, publication year, publisher, and Digital Object Identifier (DOI). For example, some journals require American Psychological Association (APA) style, while others may require Modern Language Association (MLA), Chicago, or Institute of Electrical and Electronics Engineers (IEEE) styles.

As a result, the manuscript authors face the inconvenience of having to review the reference format required by the target journal and manually adjust the existing references to conform to the required format before submission. In particular, when the number of references is large or the format rules are complex, the conversion process may require significant time and effort, and the likelihood of errors due to mistakes may increase. Such issues may impose an unnecessary burden on researchers and cause delays in the submission and publication process of the manuscript.

According to one embodiment, the data processing unit 130 may segment the input reference data into reference data and general document data based on the format of the input reference data, and if classified as general document data, the data processing unit 130 may extract the reference data from the general document data.

The data processing unit 130 may segment the input data as reference data and general document data based on the format of the input data. The input reference data supports a variety of input formats, including text reference data, reference-specific formats like Research Information Systems (RIS) and National Library of Medicine Bibliographic (NBIB), and document formats such as PDF and DOCX.

The input reference data may generally be classified into two categories: first category is reference-specific formats (such as RIS or NBIB), and second category is document data (such as PDF or DOCX files) including references. Input data in the reference-specific format may be processed internally without any conversion, whereas input data in the document format may be used after automatic extraction of the reference text from the document.

In one example, the data processing unit 130 may extract reference data from the document data (such as PDF or DOCX) including references, using an AI model. For example, when the user uploads a PDF file including reference information to the data processing unit 130, the system may apply Optical Character Recognition (OCR) technology to convert the file into text data. Then, by analyzing the converted text, the reference section may be identified according to keywords such as “References” or “Bibliography”.

Once the reference section is identified, the data processing unit 130 may use an AI-based Natural Language Processing (NLP) model to analyze the text data in detail. The model, having been trained to understand the structural features of reference data (e.g., authors, title, publication year, DOI, etc.), may automatically identify and classify these elements within the extracted text. For example, if the reference section contains a sentence such as “Gildong HONG, Mongryong YI (2021). A Study on Data Processing Technology. ABC Journal, 15(3), 123-145”, the data processing unit 130 may analyze the sentence and subdivide it into items such as authors, publication year, title, journal name, volume, and page number, and DOI.

Then, based on the extracted information, the data processing unit 130 may convert the reference data into the data format (such as RIS or NBIB) required by the user. For example, converting the reference data into RIS format may result in structured data like “TY-JOUR,” “AU-Gildong HONG” “TI-A Study on Data Processing Technology,” and so on. Through this process, the user may prepare reference data that conforms to the journal submission format.

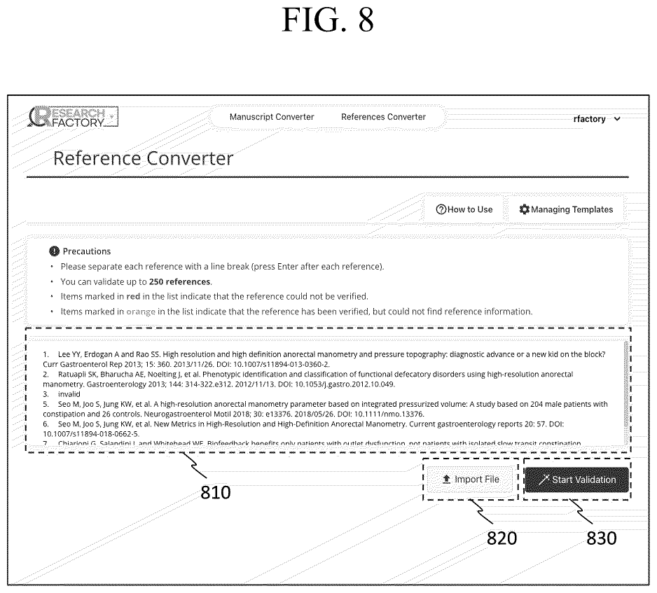

FIG. 8 illustrates components of a screen for validating references written in text. The screen may include two main components. First component is an area for notifying the user of the instructions for references validation, and second component is a text input component 810 where the user may manually input reference data in general text form. The user may review and manually input reference data using the text input component, and after inputting the text, may initiate a validation process based on the input reference data by clicking a “Start Validation” button 830.

The screen may also provide an “Import File” button 820 that allows the user to input reference data via file upload. By clicking the “Import File” button, the user may upload reference data saved in various file formats such as TXT, PDF, or DOCX. The uploaded file is internally converted into text data and then processed through the same validation process as the input data through the text input component 810.

After clicking the “Start Validation” button 830, the input data is analyzed and validated by the data processing unit, and the results are displayed on the screen. Through this, the user may confirm the accuracy of the input reference data and proceed with necessary modification or supplementation.

According to one embodiment, the data processing unit 130 may segment the bibliographic information included in reference data by type and may validate the reference data according to predefined validation rules. For example, when reference data is input, the data processing unit 130 may analyze the data and segment bibliographic information by type, such as authors, title, publication year, journal name, DOI, volume, and page number. For example, in the input reference data, “Gildong HONG” and “Mongryong YI” are segmented as authors, “2021” is segmented as publication year; and “A Study on Data Processing” is segmented as title.

The data processing unit 130 may apply validation rules based on the segmented data to verify accuracy and completeness. When the validation result is obtained, the user may manually correct errors or configure the data processing unit 130 to automatically correct simple errors.

According to one embodiment, the data processing unit 130 may retrieve a database (DB) based on the bibliographic information included in the reference data and retrieve validation reference data having similarity that meets or exceeds a certain threshold. Subsequently, when validation reference data is retrieved, if all predefined essential bibliographic information is included in the validation reference data, the validation may be determined as success. If validation reference data is retrieved but some of the predefined essential bibliographic information is missing, the validation may be determined as partially erroneous. If no validation reference data is retrieved, the validation may be determined as failed.

For example, the data processing unit 130 may retrieve a database (DB) based on the bibliographic information included in the reference data and retrieve validation reference data having similarity that meets or exceeds a certain threshold. In this process, the data processing unit 130 may compare the input bibliographic information with literature data in the database and calculate the similarity to identify the most suitable validation reference data. The similarity may be calculated based on bibliographic information such as authors, title, publication year, journal name, and DOI. Even if some items only partially match, if the similarity meets or exceeds a certain threshold, the result may be determined as the validation reference data.

Subsequently, when the validation reference data is retrieved, the data processing unit 130 may verify whether the validation reference data includes all predefined essential bibliographic information, and determine the validation result accordingly. For example, if validation reference data is retrieved and includes all essential bibliographic information, the validation may be determined as success. Conversely, if validation reference data is retrieved but some of the essential bibliographic information is missing, the validation may be determined as partially erroneous. For example, if authors, title, and publication year match, but DOI is missing, the result may be determined as partially erroneous. Finally, if no validation reference data is retrieved, that is, if no similar reference is found in the database for the input reference data, the validation may be determined as failed.

According to one embodiment, if the validation is determined as success or partial errors, the data processing unit 130 may use the retrieved validation reference data as reference data for conversion according to the format of the target journal. For example, using the validation reference data as reference data means that the input reference data is not directly used, but rather the conversion is performed based on the validation reference data retrieved from the database. In other words, the input reference data may be excluded during the conversion process, and the final conversion may be performed using only the validation reference data.

For example, assuming that the reference data input by the user includes incomplete bibliographic information, such as “Author: Gildong HONG”, “Title: A Study on Data Analysis”, and “Journal name: ABC Journal”, the data processing unit 130 may retrieve the database and search validation reference data for the corresponding manuscript. The retrieved data may include more complete bibliographic information such as “Author: Gildong HONG, Mongryong YI”, “Title: A Study on Data Analysis: Theory and Experiment”, “Publication Year: 2021”, “Journal name: ABC Journal”, “Volume: 15”, “Pages: 123-145”, and “DOI: 10.1234/abc.2021.001”. In this case, the data processing unit 130 may perform the conversion based on the retrieved validation reference data instead of using the reference data input by the user.

According to one example, when the validation is determined as failed, if all predefined essential bibliographic information is included in the reference data, the data processing unit 130 may perform conversion according to the format of the target journal using the reference data. However, if some of the predefined essential bibliographic information is not included in the reference data, the conversion may not be performed.

If the validation of the input reference data is determined as failed, the data processing unit 130 may perform conversion according to the format of the target journal using the reference data as is. However, the decision to perform the conversion in this process depends on the inclusion of all predefined essential bibliographic information in the reference data. That is, if all essential bibliographic information is included, the conversion is performed. However, if some essential bibliographic information is missing, the conversion may not be performed.

For example, assuming that the reference data input by the user includes only partial information, such as “Author: Gildong HONG”, “Title: A Study on Data Analysis”, and “Journal name: ABC Journal”, with other information (e.g., publication year, volume, page number, and DOI) missing, the data processing unit 130 may attempt to retrieve validation reference data from the database. However, if the corresponding manuscript does not exist in the database, the validation may be determined as failed. In this case, the data processing unit 130 determines whether to perform the conversion based on the reference data itself.

If all predefined essential bibliographic information (e.g., authors, title, publication year, journal name, etc.) is included in the reference data, the data processing unit 130 may perform the conversion using the reference data. For example, if the target journal requires American Psychological Association (APA) style, the converted result may be output in a format such as “HONG, G. (2021). A Study on Data Analysis. ABC Journal”. On the other hand, if some of the essential bibliographic information is missing from the reference data, the data processing unit 130 may not perform the conversion. For example, in case that the journal style requires publication year or DOI to be included, and such information is missing, the conversion may not be performed and the user may be prompted to manually supplement the missing information.

According to one embodiment, the data processing unit 130 may retrieve a database based on bibliographic information included in the reference data to extract validation reference data having a similarity that meets or exceeds a certain threshold. The data processing unit 130 may then validate the reference data based on the reference data, the validation reference data, and the format of the designated target journal, and may determine the validation result for each reference data as one of success, partial errors, or failure.

For example, the data processing unit 130 may retrieve a database based on bibliographic information included in the reference data to extract validation reference data having a similarity that meets or exceeds a certain threshold. In this process, the data processing unit 130 may utilize a highly reliable external manuscript database or a proprietary internal database. The retrieval process may be performed using heuristic method to search the most relevant data, even if the input reference data does not exactly match the literature data saved in the database.

The heuristic retrieval method is designed to match appropriate items even when the input text only approximately corresponds to the literature data saved in the database. For example, if the user inputs “Arch. Arg. Pediatr.” as journal name, it may be matched with “Archivos argentinos de pediatria” saved in the database. This increases the likelihood of linking the input reference data to a validatable reference data that actually exists.

The validation process focuses on verifying the accuracy and reliability of the input data. The data processing unit 130 may retrieve a database based on key bibliographic information, including authors, title, journal name, publication year, volume, page number, DOI, Publisher Item Identifier (PII), and unique identifier (ID), and extract literature data having a high similarity. For example, the presence of the relevant literature in the database may be verified based on the DOI or a combination of authors and title information of the manuscript input by the user. If the relevant literature is uniquely identified in the database, the relevant literature may provide sufficient evidence to be considered a validated reference.

For example, the data processing unit 130 may calculate similarity by assigning different weights depending on the type of bibliographic information, and extract validation reference based on the calculated similarity. For example, title and authors in the reference data may be considered core elements for identifying a literature and may be assigned higher weights, whereas page number and volume information may be regarded as auxiliary elements and assigned relatively lower weights. This approach allows the data processing unit 130 to comprehensively calculate similarity between the input reference data and the literature saved in the database, and to select the most appropriate validation reference.

For example, assume that the reference data input by the user includes: “Author: Gildong HONG, Mongryong YI”, “Title: A Study on Data Processing Technology”, “Publication year: 2021”, “Journal name: ABC Journal”, “Volume: 15”, and “Page number: 123-145”. The data processing unit 130 may retrieve the database by assigning a higher weight to the similarity of title and authors, while using volume and page number as auxiliary factors in the similarity calculation. In this case, even if the title saved in the database is “A Study of Data Processing Technology” and the authors are represented as “H. Gil-dong” and “Yi Mongryong”, the high similarity in title and authors may lead to the literature being determined to be the same.

Additionally, the data processing unit 130 may configure different similarity thresholds depending on the type of bibliographic information. For example, in the case of title, a match may be determined even if there are typographical errors or variations in word order. In contrast, for authors, the threshold may be set more leniently to account for abbreviations or missing of certain authors, thereby allowing the literature to still be considered the same. Such similarity calculation and threshold configuration mechanism enable the data processing unit 130 to compensate for format errors or variations that may occur during data input, and to efficiently extract the most relevant validation reference from the database.

The data processing unit 130 may validate the reference data based on the reference data, the validation reference data, and the format of the designated target journal, and may determine the validation result for each reference data as one of success, partial errors, or failure.

For example, validation success refers to a case in which the input reference data either exactly matches the validation reference data retrieved from the database (DB), or is determined to have a similarity that meets or exceeds a certain threshold, thereby enabling complete acquisition of the required data. In this case, the data processing unit 130 may directly utilize the validation success data during the conversion and output process.

According to one embodiment, the data processing unit 130 may determine validation success when the reference data matches the validation reference data according to predefined rules for each type of bibliographic information, and includes essential bibliographic information required by the format of the designated target journal.

For example, the data processing unit 130 may compare the input reference data with the validation reference data retrieved from the database based on key bibliographic information such as authors, title, publication year, journal name, and DOI. In this process, the data processing unit 130 may determine whether the bibliographic information matches according to predefined rules. For example, in the case of authors, a match may be determined even if abbreviations are used or some authors are missing. In the case of a title, a match may be determined even if there are typographical errors or variations in word order, provided that the similarity is sufficiently high.

In addition, to determine whether validation is successful, the data processing unit 130 may analyze the format of the designated target journal to verify the essential bibliographic information. The essential bibliographic information required by the format of the target journal may include, for example, key elements such as authors, title, publication year, and DOI. The data processing unit 130 may verify whether the input reference data includes all of the essential bibliographic information, and may determine validation success only when the requirements are satisfied.

For example, a partially erroneous case refers to a status in which the input reference data is matched in the database, but the corresponding validation reference data lacks some essential bibliographic information. For example, title, authors, and DOI may be matched, but certain metadata such as publication year (Pubdate) or page number (Page) may be missing. In such a case, the data processing unit 130 may attach a specific marker to the result to explicitly notify the user that the data is incomplete, and may guide the user to manually input the missing data. However, if the missing data is not considered essential under the journal format, it may not significantly affect the manuscript submission process.

According to one embodiment, the data processing unit 130 may determine validation failure when no validation reference data having a similarity that meets or exceeds a certain threshold is retrieved from the database based on the reference data.

For example, validation failure may refer to a case in which the input reference data is not matched in the database or the similarity falls below a certain threshold. In this case, the data processing unit 130 may attempt to generate the best possible output by analyzing the input reference data and classifying the text data into bibliographic information such as authors, title, and publication year using artificial intelligence (AI). However, if the original text lacks required information, complete retrieval of the data may not be possible, and in such a case, an incomplete status may be explicitly indicated in the output so that the user may supplement the data through manual input.

According to one embodiment, the data processing unit 130 may modify the reference data based on the validation reference data if a typographical error is determined to be present through a comparison between the reference data and the validation reference data. For example, the data processing unit 130 may compare the input reference data with the validation reference data retrieved from the database, and if it is determined that a typographical error or inconsistency exists, the reference data may be automatically modified based on the validation reference data.

For example, if the user inputs a journal name as “ABC Journa” in the reference data, while the validation reference data saved in the database indicates “ABC Journal”, the data processing unit 130 may determine that a typographical error exists in the journal name field based on a comparison between the input reference data and the validation reference data. In such a case, the data processing unit 130 may correct the journal name of the input data to “ABC Journal” based on the validation reference data. The corrected data may then be used in the subsequent reference conversion and output process. In this manner, the data processing unit 130 may automatically correct minor errors in the input reference data, thereby improving the reliability and accuracy of the reference data provided by the user. In particular, it may prevent errors in the validation process that may result from typographical errors or inconsistencies in key bibliographic information such as authors, title, and journal name, and may support the user in easily utilizing correct reference data.

According to one embodiment, if one or more of the required bibliographic information defined by the format of the designated target journal is missing from the reference data but is included in the validation reference data, the data processing unit 130 may add the missing bibliographic information to the reference data based on the validation reference data and convert the modified or added reference data in accordance with the format of the designated target journal.

For example, assuming that the input reference data input by the user includes only partial bibliographic information such as “Author: Gildong HONG, Mongryong YI”, “Title: A Study on Data Processing Technology”, and “Journal: ABC Journal”, and is missing essential bibliographic information such as the publication year, page number, and DOI, the data processing unit 130 may retrieve the database based on the input data and search validation reference data that includes the missing information, such as “Publication Year: 2021”, “Page number: 123-145,” and “DOI: 10.1234/abc.2021.001”.

Subsequently, the data processing unit 130 may add the missing bibliographic information from the validation reference data to the input reference data and convert the added data to be compliant with the format of the designated target journal. For example, if the format of the target journal is IEEE style, the final output may be converted into a format such as “H. Gil-dong and Y. Mong-ryong, ‘A Study on Data Processing Techniques,’ ABC Journal, vol. 15, pp. 123-145, 2021, doi: 10.1234/abc.2021.001”.

According to one embodiment, the data processing unit 130 may output information regarding the modified or added data through the interface, along with information about partially erroneous case. In this process, the modified and added data may be visually distinguished so that the user may clearly recognize each piece of data and take further action if necessary.

For example, when the DOI information is missing from the reference data input by the user, the data processing unit 130 may add the DOI based on the validation reference data and output the added data through the interface using a different color or emphasis style (e.g., bold or underline). In addition, if the “Journal name: ABC Journa” in the input reference data is corrected to “ABC Journal” during the validation process, the modified portion may be displayed in a different format (e.g., text emphasis or annotation) to clearly convey the change to the user.

For example, the data processing unit 130 may provide an error message when certain bibliographic information is missing. For example, if publication year is missing from both the validation reference data and the input reference data, a message such as “Publication year information is missing. Manual input is required.” may be output. Such error information may be displayed together with the added and modified data, allowing the user to comprehensively recognize the status of the data and take appropriate action.

According to one embodiment, when the validation result is determined as failure, the data processing unit 130 may convert the reference data based on the format of the designated target journal and may output information via the interface indicating that the conversion was performed using only the reference data.

When the input reference data is determined to be a validation failure due to the absence of matching in the database, the data processing unit 130 may generate the best possible output based on the format of the designated target journal and may output information via the interface to inform the user of the validation failure. The validation failure refers to a status in which no matching or similar reference is retrieved in the database on the input reference data. In such a case, the data processing unit 130 may utilize an AI model to analyze and classify the input text data and convert the input text data into reference data.

For example, a case may be assumed in which the user inputs a text such as “ABC123 Journal, A Study on Data Analysis, Gildong HONG, 2020,” but no matching or similar data is found in the database. In this case, the data processing unit 130 may classify bibliographic information such as journal name, title, authors, and publication year from the input text, and convert the reference data in accordance with the format of the designated target journal. Since the converted result is generated by utilizing the input text as much as possible, there may be a possibility that some information is missing.

If the input text itself does not contain essential bibliographic information, such as volume number or DOI, the data processing unit 130 may output the result with the missing information since it cannot supplement the absent information. In such a case, the interface may provide information indicating that the conversion was performed with missing information and may specify which essential information is missing, thereby prompting the user to manually input the missing data. For example, a message such as “Volume number information is missing. Manual input is required.” may be output.

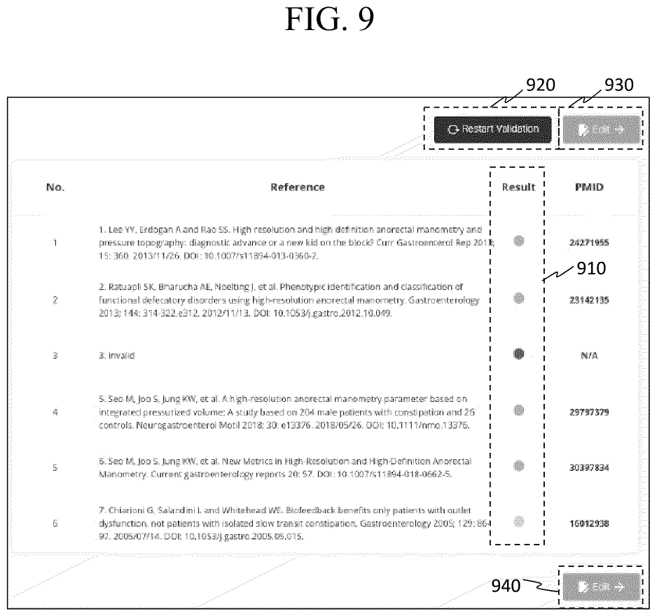

FIG. 9 illustrates components of a screen for intuitively displaying the results of validated reference data to the user. The validation results may be displayed in the “Result” column 910 with colors indicating the validation status. A green indicator represents a validation success, indicating that the input reference data has been confirmed as reliable data from the database (DB). A red indicator represents a validation failure, indicating that no matching or similar items were found in the database for the input data. An orange indicator represents a validation success even though some data could not be retrieved, notifying that the results may include missing information.

For example, an item indicated by a green indicator represents a validated item, such as “Author: Gildong HONG, Mongryong YI” and “Title: A Study on Data Processing Technology”, which the user may utilize without any additional action. In contrast, an item indicated by a red indicator represents an item determined as validation failure, such as “Author: Gildong HONG” and “Title: A Methodology for Data Analysis”, requiring the user to review or supplement the data. An item indicated by an orange indicator represents a validated that has successfully passed validation but lacks some bibliographic information (e.g., publication year, page number), such as “Author: Mongryong YI” and “Title: A Study on Data Integration”.

Based on the validation results, the user may perform additional operations. The user may re-validate the data with validation failure or partial errors by clicking a “Restart Validation” button 920, upon which the input reference data is re-validated and the results are updated. After completing the validation, the user may proceed to the reference conversion stage by clicking an “Edit” button 930 or 940 to supplement the data.

According to one embodiment, the data processing unit 130 may output a list of one or more pieces of bibliographic information through the interface, receive an input selecting at least one from the one or more pieces of bibliographic information included in the list from the user, and receive detailed configuration information for the selected one of more pieces of bibliographic information to configure the format of the target journal. In this case, a drag-and-drop method may be used for selecting the one or more pieces of bibliographic information.

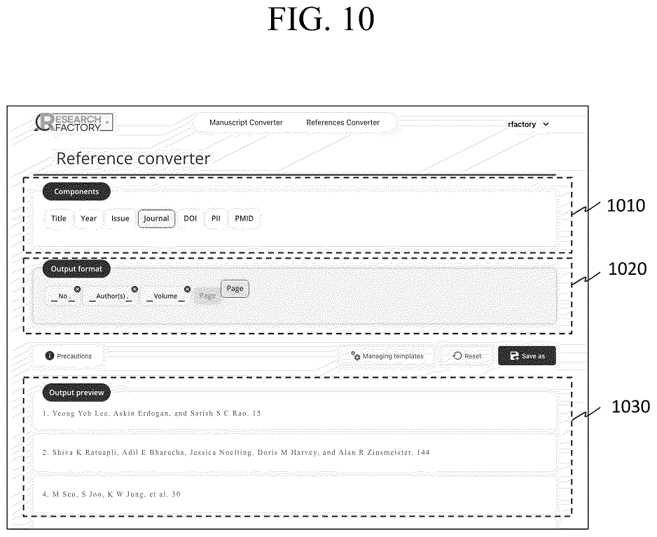

The data processing unit 130 may output a list of one or more pieces of bibliographic information through the interface, receive an input from the user selecting and dragging and dropping the bibliographic information from the list, and configure the format of the target journal based on the detailed configuration information of the selected bibliographic information. Referring to FIG. 10, components 1010 may visually provide each bibliographic information element, such as authors, title, publication year, and journal name, as an independent component. The user may drag and drop each element into an output format 1020 and freely arrange the order of the elements. Through this, the user may easily configure the template of the references and adjust the order and format to comply with the requirements of the target journal.

Additionally, an output preview 1030 may output the converted reference result by reflecting the template information configured by the user in real time. For example, if the user arranges the bibliographic information in the order of authors, publication year, title, and journal name, the output preview component may immediately display the converted result such as “Gildong HONG, 2021, A Study on Data Processing Technology, ABC Journal”. This real time preview function helps the user visually verify whether the configured template complies with the format required by the target journal.

Such an interface supports the user in configuring a reference template more efficiently and flexibly through intuitive drag-and-drop configuration and verification of the result in real time. As a result, reference data conforming to the requirements of the target journal may be easily generated during the manuscript writing and submission process.

In one example, the data processing unit 130 may provide a function for managing and saving the reference template through the interface by providing a “Managing templates” button and a “Save as” button. This function is designed to allow the user to load previously saved template information or to generate and save a new template.

The “Managing templates” button may serve to allow the user to load previously saved template information. When the button is clicked, a list of saved templates may be displayed, and the user may select a desired template to apply it to the output format component. Through this, the user may quickly retrieve frequently used templates, thereby reducing repetitive work and efficiently configuring the reference format.

The “Save as” button may provide a function for generating and saving a new template. When the user has completed the arrangement and detailed configuration of the bibliographic information elements in the Output format component, the user may click the “Save as” button to save the current configuration information as a new template with a designated name. The saved template may later be retrieved and reused when needed.

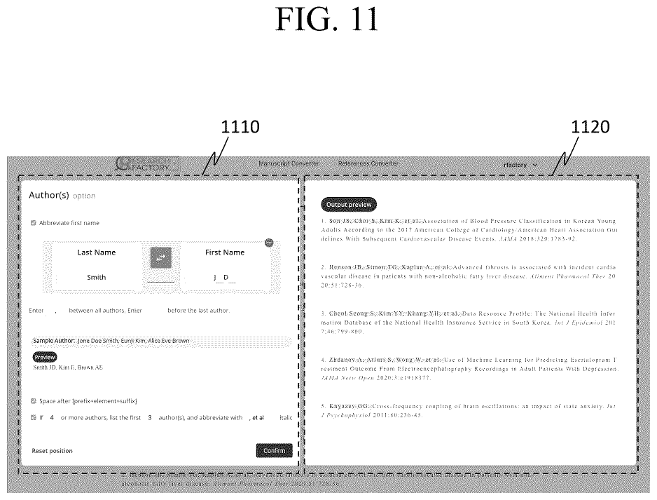

FIG. 11 illustrates a process in which the data processing unit 130 outputs a detailed option configuration window for each bibliographic element (e.g., title, authors, etc.) through the interface and receives user input to apply the corresponding configuration. Each element component may allow detailed option configuration, and the user may flexibly adjust the format through the interface to meet the requirements of the target journal.

For example, an option configuration window 1110 of the author component may provide various configurations for adjusting the name format of the author. In the example of the option configuration window 1110 of the author component shown on the screen, the user may select how to display the author's name (e.g., First Name, Last Name). In this option configuration window, when a (−) button located at the upper-right corner of the First Name component is clicked, the First Name item may be deactivated, and as a result, only the Last Name is displayed. In this manner, the user may easily adjust the display format of the author's name according to the requirements of the target journal.

The data processing unit 130 may receive user input, save the corresponding configuration, and reflect the configuration on the screen in real time. For example, when the user deactivates the First Name and configures only the Last Name to be displayed in the author component, the interface may immediately reflect the modified configuration to an output preview 1120 and may output the result accordingly. This allows the user to immediately verify the configuration changes and perform additional modifications if necessary.

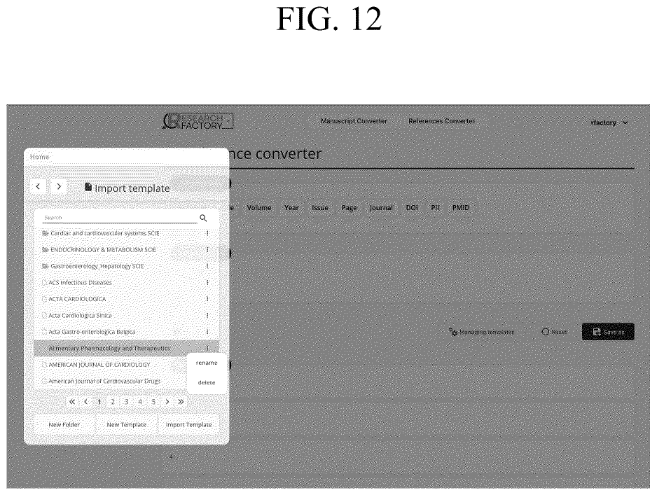

FIG. 12 illustrates a process in which the data processing unit 130 loads and manages saved templates through the interface. Option information configured by the user may be saved as a template for later use, and preset templates that have already been generated may also be loaded and used.

The saved templates may be managed in a folder structure, supporting the user with intuitive template management. On the interface, the user may rename or delete a template, and a function for moving templates between folders may also be provided. Such a folder structure helps the user systematically classify and manage templates according to different journals or projects.

In FIG. 12, a list of saved templates may be output, and the user may select a desired template and load it into the current configuration value using an “Import” button. This allows the user to directly apply an existing template or modify it if necessary. In addition, the user may manually rename a template displayed in the list or delete unnecessary template.

Such a template management function supports the user in efficiently reusing frequently used configuration and systematically managing templates, thereby enabling quick adaptation of reference data formats to the requirements of the journal.

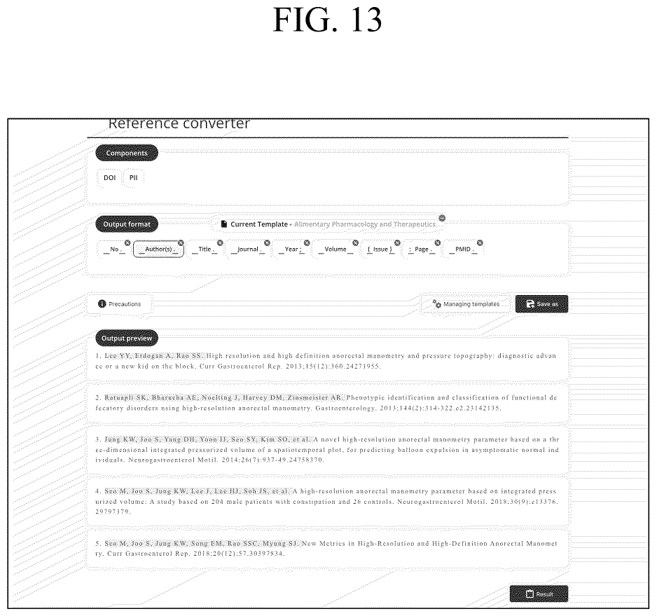

FIG. 13 illustrates a process of loading a saved template and verifying the result of converting reference data based on the loaded template. When the user loads a saved template, the value configured in the template may be immediately applied, and the format of the reference data may be modified accordingly. This process is designed to allow the user to verify in real time whether the configured template has been properly applied.

A “Result” button may be provided at the bottom right of the screen, and when the user clicks this button, the screen may display a result output screen in which the converted results for the entire list of input reference are output. On the result output screen, the converted reference data may be displayed in a format generated according to the template configuration value, and the user may review the final output and perform modification if necessary.

According to one embodiment, the data processing unit 130 may receive guide information regarding the format of the target journal through the interface and may configure the format of the target journal based on the guide information. The guide information may include essential bibliographic information required by the journal (e.g., authors, title, publication year, DOI, etc.) and detailed configuration for each bibliographic element (e.g., author name display style, capitalization rules for titles, and the order of bibliographic information).

For example, if the guide information of a specific journal includes requirements such as “Author's name must be displayed in the order of Last Name, First Name. Title must begin with a capital letter only for the first word. Bibliographic information must be arranged in the order of authors>title>journal name>publication year>volume>pages>DOI”, the data processing unit 130 may analyze the requirements and extract components and display rules for the bibliographic information. The extracted information may then be applied to the output format component to generate a template that conforms to the format of the target journal. The generated template may immediately provide the user with the converted result in real time through a preview function, and the user may further modify it if necessary.

Additionally, the data processing unit 130 may improve the efficiency of automatically processing guide information and configuring formats by utilizing an AI model. The AI model may use natural language processing (NLP) techniques to analyze bibliographic information components and formatting rules defined in the guideline. For example, the AI model may analyze a sentence such as “Author names should be in the format: Last Name, First Name” to extract the author's name display style and reflect it in the template. The extracted information may then be mapped to the data model of the data processing unit to generate a template, thereby enabling rapid adaptation to various journal formats.

The configured template may be saved in the data processing unit 130 and utilized to convert reference data according to the format of the target journal. This approach minimizes manual work by the user and enables accurate and efficient compliance with journal requirements through AI model based analysis.

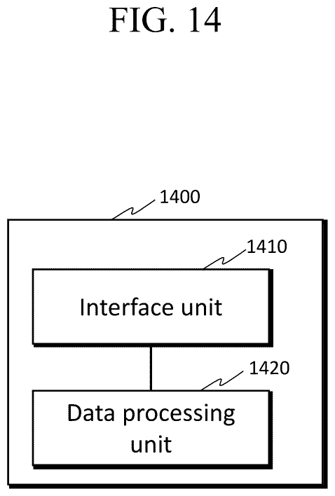

FIG. 14 is a block diagram illustrating a reference data generation apparatus according to one embodiment.

According to one embodiment, the reference data generation apparatus 1400 may include an interface unit 1410 configured to perform data input and output, and a data processing unit 1420 configured to validate the input reference data received through the interface unit 1410 and convert the input reference data based on the validation result and the format of the designated target journal.

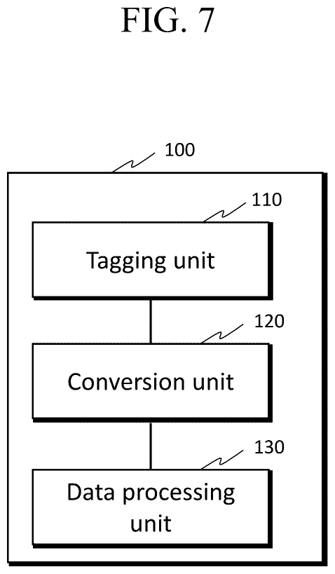

In one example, the reference conversion function of the manuscript conversion apparatus 100 may be implemented as a separate reference data generation apparatus. In this case, the data processing unit 1420 may perform the same functions as the data processing unit 130 described with reference to FIGS. 1 to 13.

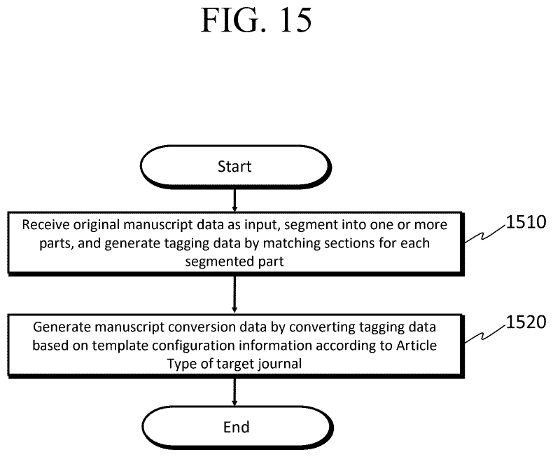

FIG. 15 is a flowchart illustrating a manuscript conversion method according to one embodiment.

According to one embodiment, the manuscript conversion apparatus may be a computing device comprising one or more processors and a memory storing one or more programs executed by the one or more processors.

According to one embodiment, the manuscript conversion apparatus may receive original manuscript data as input, segment the original manuscript into one or more parts, and generate tagging data by matching sections for each segmented part, step 1510, and may generate manuscript conversion data by converting the tagging data based on template configuration information according to the Article Type of the target journal, step 1520.

Redundant descriptions with FIGS. 1 to 14 are omitted in the embodiment of FIG. 15.

An aspect of the present invention may be implemented as computer-readable code on a computer-readable recording medium. The codes and code segments for implementing the above-described program can be easily inferred by those skilled in the art of computer programming. A computer-readable recording medium may include all types of recording devices in which data readable by a computer system are stored. Examples of the computer-readable recording medium may include ROM, RAM, CD-ROM, magnetic tapes, floppy disks, optical disks, and the like. Furthermore, the computer-readable recording medium may be distributed over network-connected computer systems so that the code can be stored and executed in a distributed manner.

The present invention has been described above with reference to certain preferred embodiments. However, those skilled in the art to which the present invention pertains will appreciate that the invention may be implemented in other specific forms without departing from the essential characteristics of the invention. Therefore, the scope of the present invention should not be construed as being limited to the foregoing embodiments, but should be interpreted to include all modifications, equivalents, and alternatives falling within the scope of the appended claims.

What is claimed is:

1. A manuscript conversion apparatus comprising:
a tagging unit configured to receive original manuscript data as input and segment the original manuscript data into one or more parts, and to generate tagging data by matching sections for each segmented part; and
a conversion unit configured to convert the tagging data based on template configuration information according to an Article Type of a target journal to generate manuscript conversion data.

2. The manuscript conversion apparatus of claim 1,
wherein the tagging unit comprises an artificial intelligence (AI) model configured to receive style guide data as input and generate part classification information according to the Article Type of the target journal.

3. The manuscript conversion apparatus of claim 2,
wherein the tagging unit is configured to segment the original manuscript data into one or more parts based on the part classification information.

4. The manuscript conversion apparatus of claim 1,
wherein the tagging unit comprises an AI model configured to analyze text included in the original manuscript data based on part classification information and segment the text into parts.

5. The manuscript conversion apparatus of claim 4,
wherein the tagging unit comprises one or more AI models configured to analyze missing information in at least one of the parts.

6. The manuscript conversion apparatus of claim 5,
wherein the tagging unit is configured to output at least one of text with part segmentations indicated, section information matched to each part, and missing information.

7. The manuscript conversion apparatus of claim 6,
wherein the tagging unit is configured to receive, from user, a modification request input to modify at least one of text with part segmentations indicated, information matched to each part, and missing information.

8. The manuscript conversion apparatus of claim 7,
wherein the tagging unit is configured to train an AI model that generated information subject to the modification request, based on the modification request input.

9. The manuscript conversion apparatus of claim 1,
wherein the conversion unit is configured to determine each section as at least one of a missing section, a section requiring modification, and a section not requiring modification, based on the tagging data and the template configuration information.

10. The manuscript conversion apparatus of claim 9,
wherein the conversion unit is configured to generate the manuscript conversion data by converting the tagging data in an order of sections included in the template configuration information.

11. The manuscript conversion apparatus of claim 10,
wherein the conversion unit comprises at least one of:
one or more AI models for generating text data for a missing section; and
one or more AI models for generating text data for a section requiring modification.

12. The manuscript conversion apparatus of claim 11,
wherein the conversion unit is configured to select an AI model related to the missing section from among one or more AI models for generating text data for the missing section, and generate text data corresponding to the missing section, when converting the missing section during conversion of the tagging data.

13. The manuscript conversion apparatus of claim 12,
wherein the conversion unit is configured to select an AI model related to the section requiring modification from among one or more AI models for generating text data for the section requiring modification, and generate text data corresponding to the section requiring modification, when converting the section requiring modification during conversion of the tagging data.

14. The manuscript conversion apparatus of claim 11,
wherein the conversion unit is configured to determine a section of the tagging data to be input into AI models for the missing section and the section requiring modification, based on reference section information included in the template configuration information.

15. The manuscript conversion apparatus of claim 14,
wherein the conversion unit is configured to request user to input information, when the tagging data required as input to AI models for the missing section and the section requiring modification does not exist, or some of the tagging data is missing.

16. The manuscript conversion apparatus of claim 1,
wherein the conversion unit comprises a data processing unit configured to validate input reference data included in the original manuscript data and convert the input reference data based on a validation result and a format of a designated target journal.

17. A manuscript conversion method performed by a computing device comprising one or more processors and a memory storing one or more programs executed by the one or more processors, the method comprising:
a tagging step of receiving original manuscript data as input, segmenting the original manuscript data into one or more parts, and generating tagging data by matching sections for each segmented part; and
a conversion step of generating manuscript conversion data by converting the tagging data based on template configuration information according to an Article Type of a target journal.
